(19) United States
(12) Patent Application Publication
(10) Pub. No.: US 2021/0154770 A1
(43) Pub. Date: May 27, 2021

(54) METHOD FOR PRODUCING A COMPONENT CONTAINING COPPER USING SELECTIVE LASER SINTERING

(71) Applicant: Phoenix Contact GmbH & Co. KG, 32825 Blomberg (DE)

(72) Inventors: Tobias Alf, 33818 Leopoldshöhe (DE); Philipp Jakobs, 33098 Paderborn (DE)

(73) Assignee: Phoenix Contact GmbH & Co. KG, 32825 Blomberg (DE)

(21) Appl. No.: 16/625,616

(22) PCT Filed: Jun. 22, 2018
(86) PCT No.: PCT/EP2018/066748

§ 371 Date: Dec. 20, 2019

(30) Foreign Application Priority Data
Jun. 30, 2017 (BE) 2017/5466

(51) Int. Cl. B23K 26/342; B22F 10/28; B22F 10/64; C22C 1/04; C22C 9/00; C22F 1/08; B33Y 10/00; B33Y 40/20; B33Y 80/00; H01F 1/147; H01F 41/04; B23K 26/00; B23K 26/03; B23K 26/352; B23K 26/36

(52) U.S. Cl. CPC B23K 26/342; B23K 2101/38; B22F 10/64; C22C 1/0425; C22C 9/00; C22F 1/08; B33Y 10/00; B33Y 40/20; B33Y 80/00; H01F 1/147; H01F 41/04; B23K 26/0093; B23K 26/034; B23K 26/352; B23K 26/36; B22F 2301/10; B22F 2998/10; B22F 10/28

(57) ABSTRACT

The present invention discloses a method for producing a component containing copper by selective laser sintering, comprising the following method steps: —providing (S1) a metal power containing a copper-chromium alloy; —selectively melting (S2) the metal powder by laser radiation to produce the component; —heating (S3) the component to a temperature in the temperature range between 900° C. and 1000° C. in an oxygen-containing atmosphere; and —removing (S4) a chromium oxide layer formed on the surface of the component.

### RELATED APPLICATIONS

This application is a § 371 National Stage Application of PCT/EP2018/066748, filed Jun. 22, 2018, which claims priority benefit of Belgium Patent Application No. 2017/5466, filed Jun. 30, 2017, which applications are incorporated entirely by reference herein for all purposes.

### FIELD

The present invention relates to a method for producing a component containing copper by selective laser sintering. The present invention further relates to a component containing copper that has been produced by the method according to the invention.

### BACKGROUND ART

It is known from the prior art to use selective laser sintering for producing a component containing copper. Due to the high reflectivity of copper over a wide wavelength range of laser radiation, high-powered lasers must be used to bring about melting of a copper-containing metal powder. After the component containing copper is produced, it has a reduced electrical conductivity compared to a component that is, for example, milled out of a solid block.

To increase the electrical conductivity, it is known from the prior art to heat the component containing copper to a temperature of approximately 950° C. for a specified period of time. This heating process is always carried out under a protective gas atmosphere or under vacuum so that the copper material on the surface of the component does not oxidize. This is because such a copper oxide layer has reduced electrical conductivity.

A high electrical conductivity is essential for a current-conducting component containing copper, such as a current bar for a conductor connection terminal or an induction coil for generating a magnetic field via which a component is inductively heated. Such induction coils are also referred to as inductors or copper inductors. As a result, for methods known from the prior art for producing a component containing copper by selective laser sintering, it is absolutely necessary to heat the component to a specified temperature, for example 950° C., under a protective gas atmosphere.

### SUMMARY OF THE INVENTION

Introduction of the current-conducting component into a protective gas atmosphere and subsequent heating is a relatively complicated process. Therefore, the object underlying the present invention is to provide a method for producing a component containing copper by laser sintering, which is easier to carry out compared to methods known from the prior art.

The object underlying the present invention is achieved by a method for producing a component containing copper by selective laser sintering having the features of claim 1. Advantageous embodiments of the method are described in the claims that are dependent on claim 1.

In particular, the object underlying the present invention is achieved by a method for producing a component containing copper by selective laser sintering, wherein the method according to the invention comprises the following method steps:
providing a metal powder containing a copper-chromium alloy;
selectively melting the metal powder by laser radiation to produce the component;
heating the component to a temperature in the temperature range between 900° C. and 1000° C. in an oxygen-containing atmosphere; and
removing a chromium oxide layer formed on the surface of the component.

The copper-chromium alloy has reduced reflectivity compared to pure copper, in particular in a wavelength range between 800 nm and 1200 nm, so that reduced laser power may be used to melt the metal powder. In addition, using a copper-chromium alloy offers the advantage that during heating of the component thus formed to a temperature between 900° C. and 1000° C. in the presence of an oxygen-containing atmosphere, the chromium on the surface of the component oxidizes to form a chromium oxide layer. This chromium oxide layer may be easily removed. A component containing copper that is produced by the method according to the invention has increased electrical conductivity, it being possible to produce the component containing copper using fewer method steps.

The method is preferably designed in such a way that a metal powder containing a copper-chromium-zirconium alloy is provided for the selective melting. Such a metal powder has even further reduced reflectivity in the wavelength range of 800 nm to 1200 nm.

The method is more preferably designed in such a way that a metal powder containing a CuCr1Zr alloy is provided for the selective melting.

A CuCr1Zr alloy has a chromium mass fraction of 0.5% to 1.2%, preferably 0.85%, a zirconium mass fraction of 0.03% to 0.3%, preferably 0.15%, an iron mass fraction of less than 0.08%, and a silicon mass fraction of less than 0.1%, with copper forming the remaining mass fraction of the alloy, so that the mass fraction of copper is preferably 99%. The material designation/number of the CuCr1Zr alloy is also referred to as CW106C in Europe, and as C18150 in the United States.

When such a metal powder is used, an even further reduced laser power may be used for melting the metal powder. In addition, using such a metal powder offers the advantage that an easily stripped chromium oxide layer forms during the heating in an oxygen-containing atmosphere, which may be removed particularly easily from the surface of the component.

The method is preferably designed in such a way that the component is heated to a temperature in the temperature range between 900° C. and 1000° C. in the presence of ambient air. The method designed in this way offers the advantage that no special atmosphere has to be provided during the heating process for the component. Therefore, the method having such a design may be carried out in an even simpler manner.

The component is more preferably heated to a temperature of 950° C. It has been found that when the component is heated to a temperature of 950° C., the component designed in this way has increased electrical conductivity.

The method is more preferably designed in such a way that the removal of the chromium oxide layer takes place by compressed air blasting using solid blasting abrasive. Slag abrasive, corundum, garnet sand, plastic, glass beads, dry ice, and/or chilled cast iron may be used as solid blasting abrasive. The method having such a design may be easily carried out, and excellent results are obtained in removing the chromium oxide layer from the component.

The method is more preferably designed in such a way that the method comprises the following method steps:
providing the metal powder on a substrate;
traversing a cross-sectional contour of the component by the laser radiation;
applying additional metal powder to the formed cross-sectional contour of the component; and
re-traversing a cross-sectional contour of the component by the laser radiation.

The object underlying the present invention is further achieved by a component containing copper that has been produced by one of the above-described methods.

The component according to the invention has the advantage that it may be produced quickly by selective laser sintering and has a high electrical conductivity.

The component is preferably designed as a current-conducting component, in particular a current bar.

The component is preferably designed as an induction coil.

Induction coils, also referred to as inductors or copper inductors, are used to generate a magnetic field by means of which a metallic component is inductively heated. The geometries of the induction coils are a function of the geometries of the components to be heated, so that very good use may be made of the advantages of the method according to the invention in creating complicated geometries from components to be formed.

In addition, the component designed as an induction coil is preferably hollow.

As the result of a hollow design of the induction coil, it may be cooled by a cooling fluid flowing through it.

In addition, two end areas of the hollow induction coil preferably have a closed design.

Due to such a design of the induction coil, during the method step of heating the component to a temperature in the temperature range between 900° C. and 1000° C. in an oxygen-containing atmosphere, no chromium oxide layer forms in the interior of the hollow induction coil, so that the cavity in the induction coil is not closed off by a chromium oxide layer, and/or subsequent passage of a cooling fluid through the induction coil is not hindered.

### BRIEF DESCRIPTION OF THE DRAWINGS

Further advantages, particulars, and features of the invention result from the exemplary embodiments explained below. In the FIGURE:

FIG. 1: shows a process sequence plan for producing a component containing copper by selective laser sintering.

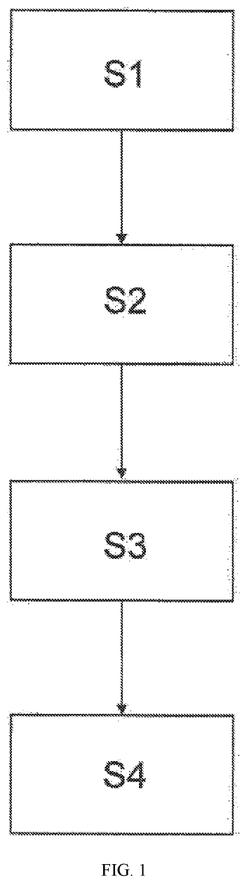

### DETAILED DESCRIPTION OF THE EMBODIMENTS

A metal powder containing copper is provided in a first method step S1. The metal powder provided for the selective melting preferably contains a copper-chromium-zirconium alloy. The metal powder provided for the selective melting more preferably contains a CuCr1Zr alloy. The metal powder is preferably provided on a substrate.

The metal powder is subsequently melted by laser radiation in a method step S2. During melting of the metal powder, it is heated by the laser radiation at least until the surfaces of the metal powder components are melted. A cross-sectional contour of the component to be produced is preferably traversed by the laser radiation in method step S2. Additional metal powder is subsequently applied to the cross-sectional contour of the component that has already formed, and is then melted once again by the laser radiation, so that the melted metal powder joins to the already produced component.

After the component has been produced by selective laser sintering, the component is heated to a temperature in the temperature range of 900° C. to 1000° C., preferably to a temperature of 950° C., in an oxygen-containing atmosphere in a method step S3. Ambient air or respiratory air is preferably used as the atmosphere. Thus, no special protective gas atmosphere is necessary during heating of the component. The chromium on the surface of the component oxidizes with the oxygen to form a chromium oxide layer that encloses the component.

The chromium oxide layer that is formed on the surface of the component is subsequently removed in a method step S4. The removal S4 of the chromium oxide layer preferably takes place by compressed air blasting using solid blasting abrasive.

1. A method for producing a component containing copper by selective laser sintering, comprising the following method steps:
providing (S1) a metal powder containing a copper-chromium alloy;
selectively melting (S2) the metal powder by laser radiation to produce the component;
heating (S3) the component to a temperature in the temperature range between 900° C. and 1000° C. in an oxygen-containing atmosphere; and
removing (S4) a chromium oxide layer formed on the surface of the component.

2. The method of claim 1, wherein a metal powder containing a copper-chromium-zirconium alloy is provided for the selective melting (S1).

3. The method of claim 1, wherein a metal powder containing a CuCr1Zr alloy is provided for the selective melting (S1).

4. The method of claim 1, wherein the component is heated (S3) to a temperature in the temperature range between 900° C. and 1000° C. in the presence of ambient air.

5. The method of claim 1, wherein the component is heated (S3) to a temperature of 950° C.

6. The method of claim 1, wherein a removal (S4) of the chromium oxide layer takes place by compressed air blasting using solid blasting abrasive.

7. The method of claim 1, further comprising:
providing the metal powder on a substrate;
traversing a cross-sectional contour of the component by the laser radiation;
applying additional metal powder to the formed cross-sectional contour of the component; and
re-traversing a cross-sectional contour of the component by the laser radiation.

8. A component containing copper that has been produced by one of the methods according to one of claims 1 to 7.

9. The component according to claim 8, wherein the component is designed as a current-conducting component.

10. The component according to claim 9, wherein the component is designed as an induction coil.

11. The component according to claim 10, wherein the component designed as an induction coil is hollow.

12. The component according to claim 11, wherein two end areas of a hollow induction coil have a closed design.
